(19) United States
(12) Patent Application Publication
(10) Pub. No.: US 2019/0367013 A1
(43) Pub. Date: Dec. 5, 2019

(54) Control Device and Method

(71) Applicant: Continental Teves AG & Co. OHG, Frankfurt am Main (DE)

(72) Inventors: Yong-Ho YOO, Eschborn (DE); Hendrik DEUSCH, Wiesbaden (DE); Frank EDLING, Schwalbach (DE)

(21) Appl. No.: 16/478,652

(22) PCT Filed: Feb. 26, 2018
(86) PCT No.: PCT/DE2018/200017

§ 371 Date: Jul. 17, 2019

(30) Foreign Application Priority Data
Apr. 5, 2017 (DE) 10 2017 205 782.3

(51) Int. Cl. B60W 30/06; G05D 1/00

(52) U.S. Cl. CPC B60W 30/06; G05D 1/0088; G05D 2201/0213; B60W 2550/20; B60W 2550/10

(57) ABSTRACT

In a control device (101) and method for a vehicle (100, 300, 400, 500, 600, 700, 800) for calculating a vehicle trajectory (102) starting from a start position (103, 303, 403, 503, 603, 703, 803) up to an end position (104, 304, 310, 311, 404, 504, 604, 704, 804), a surroundings-sensing device (105) is designed to sense free regions and occupied regions in an area surrounding the vehicle and to output corresponding surroundings information (106), and a trajectory-calculation device (107) is designed to calculate possible first collision-free trajectories for the vehicle based on the surroundings information (106) starting from the start position and to calculate possible second collision-free trajectories for the vehicle starting from the end position. The trajectory-calculation device (107) is also designed to identify at least one pair of first and second collision-free trajectories whose trajectory end positions (713, 813, 814) lie within a predefined tolerance range with respect to one another, and to output the at least one pair as a vehicle trajectory (102).

### FIELD OF The INVENTION

The present invention relates to a control device for a vehicle for calculating a vehicle trajectory starting from a start position up to an end position. The present invention further relates to a corresponding method.

### PRIOR ART

Although the present invention is mainly described below in connection with private cars, it is not restricted thereto but can be used with any type of vehicle.

In modern vehicles, the driver is more and more frequently supported by assistance systems which make possible automated or at least partially automated driving.

For example, a driver assistance system can take over the task of parking the vehicle for a driver. To do this, the driver assistance system has to select a trajectory starting from the present position of the vehicle, via which the vehicle can be moved into the parking space.

The process of calculating possible trajectories is usually very elaborate and requires a high amount of computation power.

### DISCLOSURE OF THE INVENTION

It is therefore an object of the present invention to make possible more efficient trajectory planning for vehicles.

This object is achieved by a control device having the features of the independent claim 1 and a method having the features of the independent claim 9.

Accordingly, there is provided:

A control device for a vehicle for calculating a vehicle trajectory starting from a start position up to an end position, having a surroundings-sensing device which is designed to sense free, that is to say drivable, and occupied, that is to say not drivable, regions in an area surrounding the vehicle and to output corresponding surroundings information, and a trajectory-calculation device which is designed to calculate possible first collision-free trajectories for the vehicle on the basis of the surroundings information starting from the start position and to calculate possible second collision-free trajectories for the vehicle starting from the end position, wherein the trajectory-calculation device is also designed to identify at least one pair of first collision-free trajectories and second collision-free trajectories whose trajectory end positions lie within a predefined tolerance range with respect to one another, and to output the at least one pair as a vehicle trajectory.

There is further provided:

A method for calculating a vehicle trajectory for a vehicle starting from a start position up to an end position, having the steps of sensing free and occupied regions in an area surrounding the vehicle and outputting corresponding surroundings information, calculating first collision-free trajectories for the vehicle on the basis of the surroundings information starting from the start position, calculating second collision-free trajectories for the vehicle on the basis of the surroundings information starting from the end position, identifying at least one pair of first collision-free trajectories and second collision-free trajectories whose trajectory end positions lie within a predefined tolerance range with respect to one another, and outputting the at least one pair as the vehicle trajectory.

The present invention is based on the realization that it is very expensive to calculate all of the possible vehicle trajectories including possible intermediate steps starting from the start position of the vehicle, as already described above regarding the prior art.

The present invention is therefore based on the realization that the computational cost for calculating a vehicle trajectory, e.g. for an automatic parking process, can be significantly reduced if possible collision-free trajectories are calculated starting from the start position and simultaneously starting from the desired end position of the vehicle.

The present invention can be used e.g. to calculate a vehicle trajectory for a parking process of the vehicle. The start position can be predefined e.g. as the current position of the vehicle. The end position can e.g. be predefined by an assistance function such as a parking assistant which can previously identify a possible parking position.

The surroundings-sensing device can e.g. have sensors which are suitable for sensing the area surrounding the vehicle. Such sensors can be e.g. ultrasonic sensors, radar sensors, LIDAR sensors or the like. However, the surroundings-sensing device can e.g. also be a central control unit in the vehicle, which compiles a surroundings model for the vehicle on the basis of sensor data of other systems and provides said surroundings model to other vehicle systems such as e.g. to the control device according to the invention.

The present invention further provides the trajectory-calculation device. The trajectory-calculation device calculates the first collision-free trajectories mentioned above starting from the start position and the second collision-free trajectories starting from the end position.

The term “collision-free trajectories” denotes trajectories of the vehicle which the vehicle can cover without colliding with an obstacle in the vehicle surroundings. It is understood that e.g. minimum spacings from the objects or respectively obstacles can also be predefined which must not be fallen short of.

If the trajectory-calculation device has calculated the first trajectories and the second trajectories, said trajectory-calculation device checks whether the trajectory end positions of at least a first and a second trajectory lie within the predefined tolerance range with respect to one another.

The tolerance range can be chosen such that the vehicle can swivel from the trajectory end position of the first trajectory into the trajectory end position of the second trajectory.

The vehicle can consequently follow the selected first trajectory and, subsequently, the selected second trajectory in order to travel from the start position to the end position. The control device can e.g. be designed to control the vehicle without the assistance of the driver on the selected first trajectory and, subsequently, the selected second trajectory, in order to reach the end position. Alternatively, the control device can output the selected first trajectory and the selected second trajectory to an appropriate assistance system.

The computational cost for calculating the vehicle trajectory from the start position to the end position is significantly lowered by the bilateral approach of the present invention since the number of variants to be checked is drastically reduced.

Advantageous embodiments and further developments are set out in the subordinate claims as well as in the description with reference to the figures.

In an embodiment, the trajectory-calculation device can be designed to calculate the first trajectories and the second trajectories as the shortest possible trajectories.

One possible way of calculating such trajectories is specified e.g. in the dissertation “Two-step Trajectory Planning for Automatic Parking” by Bernhard Robert Müller, see in particular “3.2.2 Shortest Admissible Trajectory Sequences according to Reeds and Shepp”.

In an embodiment, the tolerance range can be predefined in such a manner that it is possible for the vehicle, according to its driving physics parameters, to swivel from the end position of the first trajectory into the end position of the second trajectory and to follow said trajectory.

The tolerance range can thus refer e.g. to a distance between the end positions. However, the tolerance range can at the same time also take account of e.g. the angles of the trajectories with respect to one another. For example, the maximum permitted angle between the first and the second trajectory at the end points thereof can correspond to the maximum angle which the vehicle can overcome.

In an embodiment, the trajectory-calculation device can be designed to calculate the first trajectories and the second trajectories as a combination of a circular path and a straight line and/or as a combination of a circular path and a circular path and/or as a combination of a circular path and a circular path and a straight line.

The restriction of possible forms of the trajectories makes possible a simple calculation of the trajectories.

In an embodiment, the trajectory-calculation device can be designed to calculate the trajectories with a predefined angular resolution starting from the respective initial position.

The term “angular resolution” hereby denotes the angular resolution, with which the surroundings around the vehicle are “scanned”. For example, at an angular resolution of 90°, only one line forwards, one upwards, one downwards and one backwards would be verified. At a resolution of 2° it would accordingly be 180 straight lines (all these straight lines intersect in the vehicle origin). The calculation of the trajectories ends if a collision with an object or respectively obstacle is established.

In an embodiment, the trajectory-calculation device can be designed to transform the trajectory end positions into a coordinate system of the end position and to check whether the trajectory end positions lie within a predefined tolerance range with respect to one another in the coordinate system of the end position.

If the trajectories are both situated in the same coordinate system, a comparison of the trajectory end positions is simplified. The coordinate system of the end position can have its origin e.g. in the end position.

In an embodiment, the trajectory-calculation device can be designed if the respective trajectory end positions do not lie within a predefined tolerance range with respect to one another for any pair of the first trajectories and the second trajectories, to identify those trajectory end positions of a first trajectory and a second trajectory which have the smallest spacing with respect to one another, and to choose the trajectory end position of the identified second trajectory as the intermediate end position. The trajectory-calculation device can further be designed to calculate possible second collision-free trajectories for the vehicle starting from the intermediate end position, and to identify at least one pair of first collision-free trajectories and the second collision-free trajectories calculated on the basis of the intermediate end position whose trajectory end positions lie within the predefined tolerance range with respect to one another.

If no end points of a first trajectory and a second trajectory lie within the tolerance range with respect to one another, the present invention thus provides that the first trajectories and second trajectories already calculated are used as intermediate results, which constitute the basis for the further calculation. Starting from the trajectory end positions lying closest to one another, the original calculation is consequently repeated at least for the second trajectories.

In an embodiment, the trajectory-calculation device can be designed to iteratively identify those trajectory end positions of a first trajectory and a second trajectory which have the smallest spacing with respect to one another, and to calculate possible second collision-free trajectories for the vehicle starting from the intermediate end position of the respective second trajectory until at least one pair of first collision-free trajectories and the second collision-free trajectories calculated on the basis of the intermediate end position can be identified whose trajectory end positions lie within the predefined tolerance range with respect to one another.

As already stated above, the present invention uses the results of previous calculation steps and does not attempt to calculate all of the possibilities, in order to select a suitable trajectory. As a result, the computational cost is significantly reduced.

In the case of the iterative solution to the search for a trajectory, a stop criterion such as e.g. a maximum number of iterations can additionally be predefined.

The above configurations and further developments can be combined in any way with one another, provided this is sensible. Further possible configurations, further developments and implementations of the invention also comprise combinations of features of the invention which are described above or below with respect to the embodiments, including those which are not explicitly indicated. In particular, the person skilled in the art will also add individual aspects as improvements or supplements to the respective basic form of the present invention.

The control device can be designed e.g. as a control unit in the vehicle. The control device can additionally be designed from a group of control units. The control device can further be designed as a combination of hardware and software. For example, the functions of the control device can be executed as a computer program in a computing device or a group of computing devices.

### BRIEF DESCRIPTION OF THE DRAWINGS

The present invention is explained in greater detail below with reference to the exemplary embodiments indicated in the schematic figures of the drawings, wherein:

FIG. 1 shows a block diagram of an embodiment of a control device according to the present invention,

FIG. 2 shows a flow chart of an embodiment of a method according to the present invention,

FIG. 3 shows a diagram of possible trajectories,

FIG. 4 shows a diagram having vehicle surroundings as well as a start position and an end position,

FIG. 5 shows a diagram having first collision-free trajectories,

FIG. 6 shows a diagram having second collision-free trajectories,

FIG. 7 shows a diagram having a trajectory end position and an intermediate position, and

FIG. 8 shows a diagram having a final trajectory.

In all of the figures, elements and devices which are the same or which have the same function have been provided with the same reference numerals, unless otherwise indicated.

### EMBODIMENTS OF THE INVENTION

FIG. 1 shows a block diagram of an embodiment of a control device 101 which is arranged in a vehicle 100.

The control device 101 has a surroundings-sensing device 105 which is coupled to a trajectory-calculation device 107.

The surroundings-sensing device 105 senses free and occupied regions in an area surrounding the vehicle 100 and outputs corresponding surroundings information 106.

The trajectory-calculation device 107 calculates possible first collision-free trajectories for the vehicle 100 on the basis of the surroundings information 106 starting from the start position 103. The trajectory-calculation device 107 further calculates possible second collision-free trajectories for the vehicle 100 starting from a provided end position 104.

The trajectory-calculation device 107 subsequently identifies at least one pair of first collision-free trajectories and second collision-free trajectories whose trajectory end positions lie within a predefined tolerance range with respect to one another. The at least one pair is then output as the vehicle trajectory 102.

The trajectory-calculation device 107 can calculate the first trajectories and the second trajectories, for example, as the shortest possible trajectories. One possible way of calculating such trajectories is specified e.g. in the dissertation “Two-step Trajectory Planning for Automatic Parking” by Bernhard Robert Muller, see in particular “3.2.2 Shortest Admissible Trajectory Sequences according to Reeds and Shepp”.

The first trajectories and the second trajectories can further be calculated e.g. as a combination of a circular path and a straight line and/or as a combination of a circular path and a circular path and/or as a combination of a circular path and a circular path and a straight line.

In order to reduce the computational cost, the trajectory-calculation device 107 can be designed to calculate the trajectories with a predefined angular resolution starting from the respective initial position.

The tolerance range for identifying the pair made up of the first trajectory and second trajectory can be predefined in such a manner that it is possible for the vehicle 100, according to its driving physics parameters, to swivel from the trajectory end position of the first trajectory into the trajectory end position 104 of the second trajectory and to follow said trajectory.

The trajectory-calculation device 107 can further transform the trajectory end positions into a coordinate system of the end position 104 and can check whether the trajectory end positions lie within a predefined tolerance range with respect to one another in the coordinate system of the end position 104.

If the respective trajectory end positions do not lie within a predefined tolerance range with respect to one another for any pair of the first trajectories and the second trajectories, the trajectory-calculation device 107 can perform an iterative method. The trajectory-calculation device 107 can then identify those trajectory end positions of a first trajectory and a second trajectory which have the smallest spacing with respect to one another, and choose the trajectory end position of the identified second trajectory as the intermediate end position. With this intermediate position, the trajectory-calculation device 107 can calculate possible second collision-free trajectories for the vehicle 100 and identify at least one pair of first collision-free trajectories and the second collision-free trajectories calculated on the basis of the intermediate end position whose trajectory end positions lie within the predefined tolerance range with respect to one another.

If no suitable pair is to be found in this second round either, the trajectory-calculation device 107 can continue the process iteratively.

The trajectory-calculation device 107 can again identify those trajectory end positions of a first trajectory and a second trajectory which have the smallest spacing with respect to one another, and calculate possible second collision-free trajectories for the vehicle 100 starting from the intermediate end position of the respective second trajectory until at least one pair of first collision-free trajectories and the second collision-free trajectories calculated on the basis of the intermediate end position can be identified whose trajectory end positions lie within the predefined tolerance range with respect to one another. The number of the iterations can e.g. serve as a stop criterion.

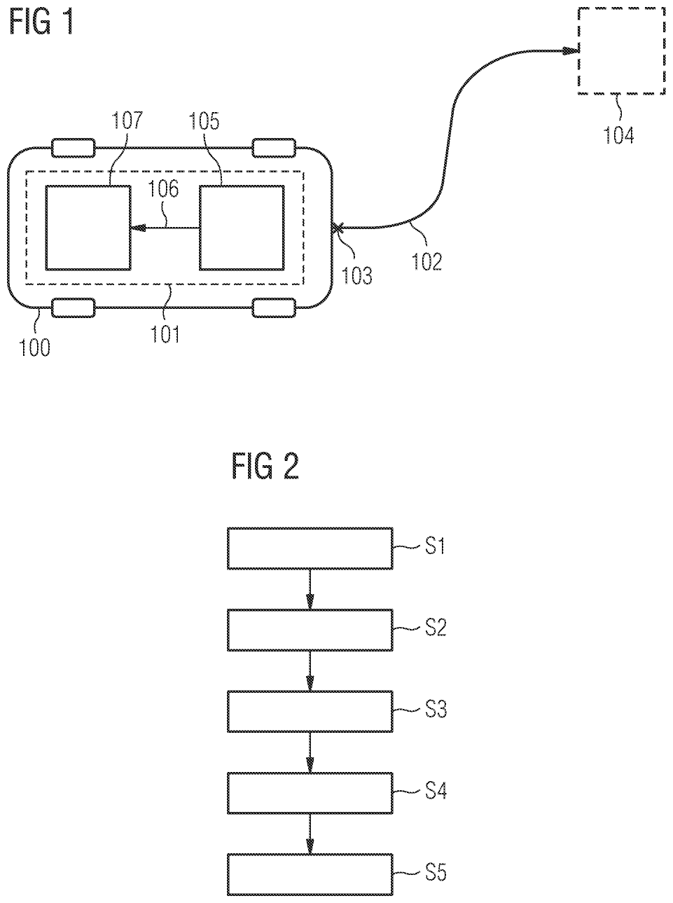

FIG. 2 shows a flow chart of an embodiment of a method for calculating a vehicle trajectory 102 for a vehicle 100, 300, 400, 500, 600, 700, 800 starting from a start position 103, 303, 403, 503, 603, 703, 803 up to an end position 104, 304, 310, 311, 404, 504, 604, 704, 804.

The method involves sensing S1 free and occupied regions in an area surrounding the vehicle 100, 300, 400, 500, 600, 700, 800 and outputting corresponding surroundings information 106. First collision-free trajectories for the vehicle 100, 300, 400, 500, 600, 700, 800 are further calculated S2 on the basis of the surroundings information 106 starting from the start position 103, 303, 403, 503, 603, 703, 803.

Second collision-free trajectories for the vehicle 100 are calculated S3 on the basis of the surroundings information 106 starting from the end position 104, 304, 310, 311, 404, 504, 604, 704, 804.

The method provides for identifying S4 at least one pair of first collision-free trajectories and second collision-free trajectories whose trajectory end positions 713, 813, 814 lie within a predefined tolerance range with respect to one another, and outputting S5 the at least one pair as the vehicle trajectory 102.

The tolerance range can be predefined in such a manner that it is possible for the vehicle 100, 300, 400, 500, 600, 700, 800, according to its driving physics parameters, to swivel from the end position 104, 304, 310, 311, 404, 504, 604, 704, 804 of the first trajectory into the end position 104, 304, 310, 311, 404, 504, 604, 704, 804 of the second trajectory and to follow said trajectory.

The first trajectories and the second trajectories can e.g. additionally be calculated as the shortest possible trajectories. The first trajectories and the second trajectories can additionally be calculated as a combination of a circular path and a straight line and/or as a combination of a circular path and a circular path and/or as a combination of a circular path and a circular path and a straight line.

The method can further provide that the trajectories are calculated with a predefined angular resolution starting from the respective initial position.

The trajectory end positions 713, 813, 814 can be additionally transformed into a coordinate system of the end position 104, 304, 310, 311, 404, 504, 604, 704, 804 and it can be checked whether the trajectory end positions 713, 813, 814 lie within a predefined tolerance range with respect to one another in the coordinate system of the end position 104, 304, 310, 311, 404, 504, 604, 704, 804.

If a first round of the method does not produce a result, if e.g. the respective trajectory end positions 713, 813, 814 do not lie within a predefined tolerance range with respect to one another for any pair of the first trajectories and the second trajectories, those trajectory end positions 713, 813, 814 of a first trajectory and a second trajectory can be identified which have the smallest spacing with respect to one another.

The trajectory end position 713, 813, 814 of the identified second trajectory can be chosen as the intermediate end position. Starting from the intermediate end position, possible second collision-free trajectories for the vehicle 100, 300, 400, 500, 600, 700, 800 can then be calculated, and at least one pair of first collision-free trajectories and the second collision-free trajectories calculated on the basis of the intermediate end position are identified whose trajectory end positions 713, 813, 814 lie within the predefined tolerance range with respect to one another.

The method can then be performed iteratively until a result is provided. To this end, those trajectory end positions 713, 813, 814 of a first trajectory and a second trajectory can be iteratively identified which have the smallest spacing with respect to one another. Starting from the intermediate end position of the respective second trajectory, possible second collision-free trajectories for the vehicle 100, 300, 400, 500, 600, 700, 800 can be calculated until at least one pair of first collision-free trajectories and the second collision-free trajectories calculated on the basis of the intermediate end position is identified whose trajectory end positions 713, 813, 814 lie within the predefined tolerance range with respect to one another.

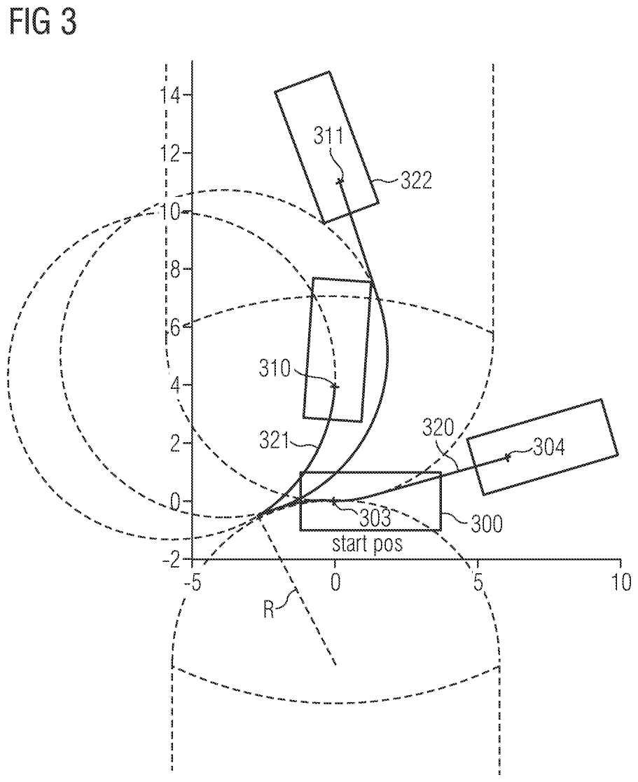

FIG. 3 shows a diagram of possible trajectories 320, 321, 322 as they can be calculated by the trajectory-calculation device 107.

The trajectories 320, 321, 322 start from a start position 303 and end in each case in the end positions 304, 310 and 311.

The trajectory 320 consists of a circular path or respectively a segment of a circular path and a straight line (driven in a forward direction).

The trajectory 321 consists of a circular path or respectively a segment of a circular path which is driven along in reverse, a circular path or respectively a segment of a circular path which is driven along in a forward direction.

The trajectory 322 consists of a circular path or respectively a segment of a circular path which is driven along in reverse, and a circular path or respectively a segment of a circular path which is driven along in a forward direction, and a straight line.

The types of trajectory described here 320, 321, 322 form the basis for the calculation of the first and second trajectories by the trajectory-calculation device. It is understood that other types of trajectory can also be used in variants.

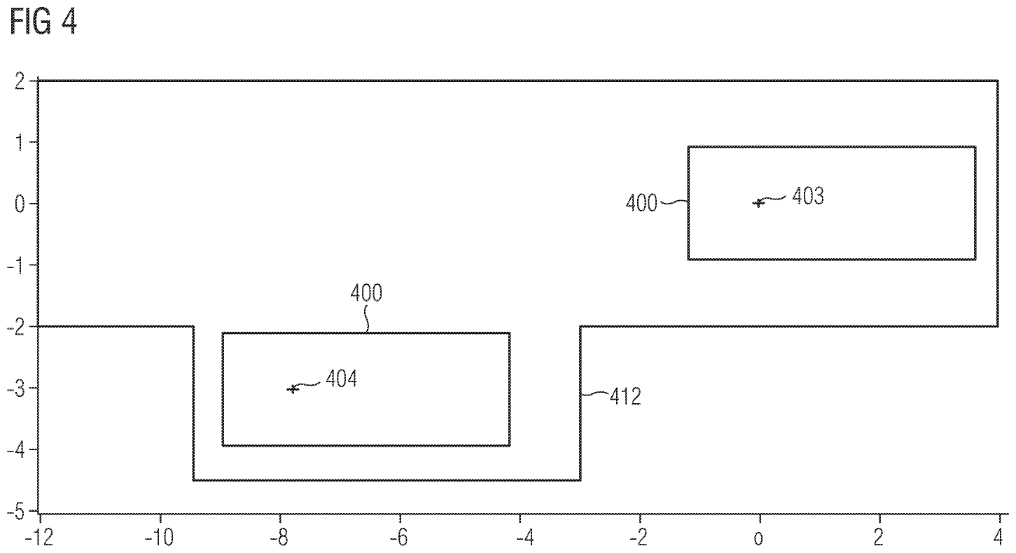

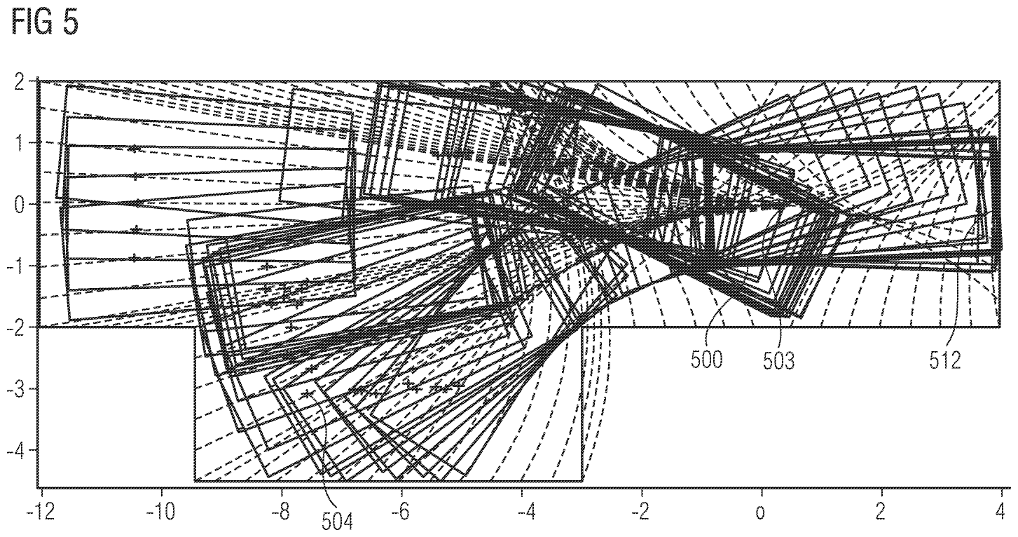

FIG. 4 shows a diagram having the vehicle surroundings of a vehicle 400, as well as a start position 403 and an end position 404. The vehicle surroundings are delimited by a boundary 412. Said boundary constitutes the objects or respectively obstacles which cannot be driven along or respectively driven over. It can be seen that the end position 404 is arranged within a (parking) space into which the vehicle 400 is to drive.

The arrangement in FIG. 4 forms the basis for the explanation of the method according to the invention in FIGS. 5 to 8.

FIG. 5 shows a diagram having first collision-free trajectories. It can be seen that possible trajectories which the vehicle 500 can drive along are calculated starting from the start position 503 of the vehicle 500. This happens both for driving in a forward direction and reversing. The respective end positions are likewise represented, but are not separately provided with reference numerals for the sake of simplicity.

It can be clearly seen that an angular resolution, as explained above, has been predefined for the calculation of the first trajectories.

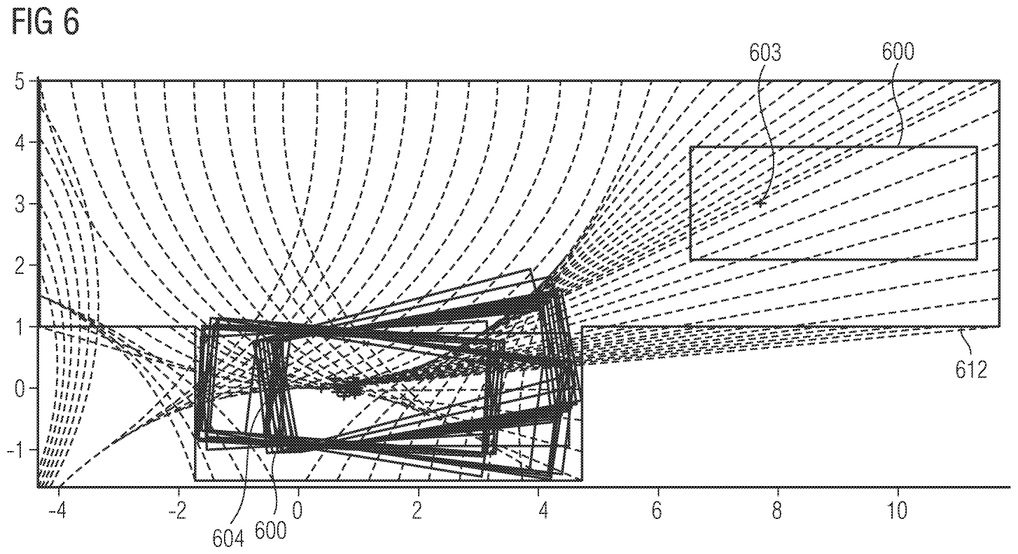

FIG. 6 shows a diagram having second collision-free trajectories. Similarly to the diagram in FIG. 5, it can be seen that possible trajectories which the vehicle 600 can drive along are calculated starting from the start position 603 of the vehicle 600. This also happens here for driving in a forward direction and reversing. The respective end positions are likewise represented, but are not separately provided with reference numerals for the sake of simplicity.

The predefined angular resolution has also been retained here.

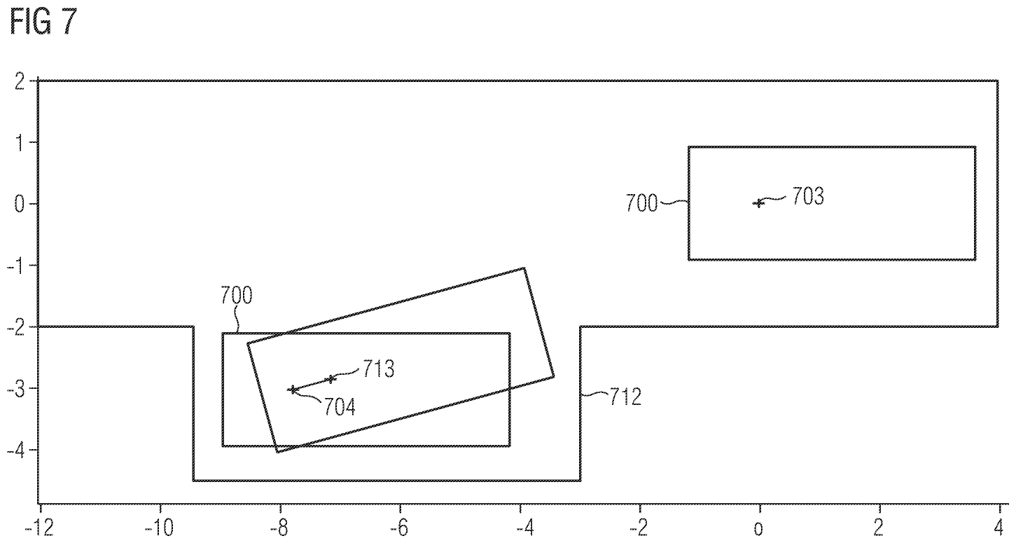

FIG. 7 shows a diagram having a trajectory end position 713. The trajectory end position 713 serves as an intermediate step, since no pair could be identified whose trajectory end positions would have been located within the predefined tolerance range with respect to one another from the first trajectories in FIG. 5 and the second trajectories in FIG. 6.

The trajectory end position 713 consequently constitutes that trajectory end position of a second trajectory which has the smallest spacing from one of the trajectory end positions of one of the first trajectories.

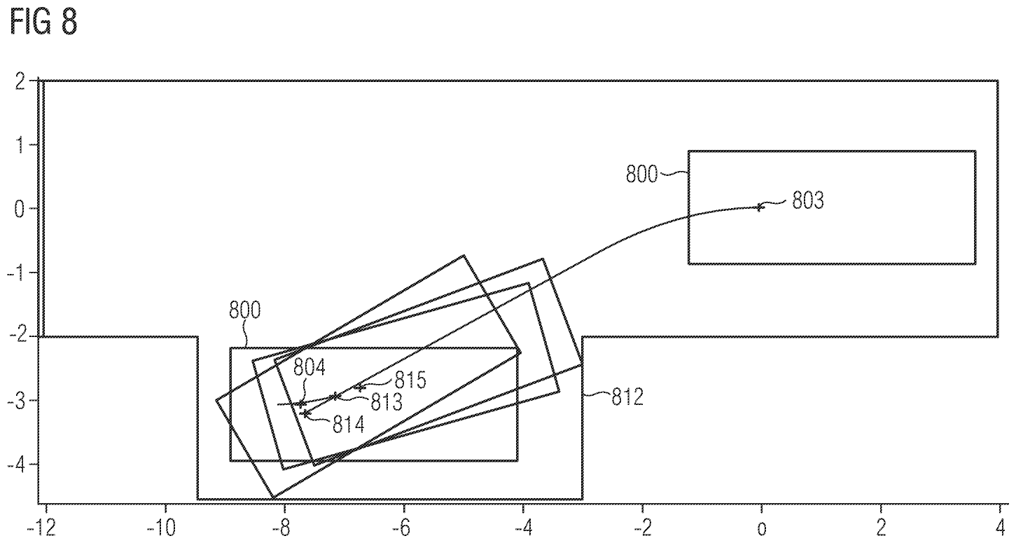

FIG. 8 shows a diagram having a final trajectory which is produced following multiple iterations of the method.

The final trajectory firstly runs to the trajectory end position 814 and from this to the trajectory end position 815. From the trajectory end position 815, the final trajectory runs to the trajectory end position 813 and, finally, to the end position 804.

Although the present invention has been described above on the basis of preferred exemplary embodiments, it is not restricted to these, but can be modified in many ways. In particular, the invention can be amended or modified in multiple ways, without deviating from the core of the invention.

### REFERENCE NUMERALS

| | |
|---|---|
| 100, 300, 400 | Vehicle |
| 500, 600, 700, 800 | Vehicle |
| 101 | Control device |
| 102 | Vehicle trajectory |
| 103, 403 | Start position |
| 503, 603, 703, 803 | Start position |
| 104, 304, 310, 311 | End position |
| 404, 604, 704, 804 | End position |
| 105 | Surroundings-sensing device |
| 106 | Surroundings information |
| 107 | Trajectory-calculation device |
| 320, 321, 322 | Trajectories |
| 412, 512, 612, 712, 812 | Boundary |
| 713, 813, 814 | Trajectory end position |
| S1-S5 | Method steps |

1. A control device (101) for a vehicle (100, 300, 400, 500, 600, 700, 800) for calculating a vehicle trajectory (102) starting from a start position (103, 303, 403, 503, 603, 703, 803) up to an end position (104, 304, 310, 311, 404, 504, 604, 704, 804), having:
a surroundings-sensing device (105) which is designed to sense free and occupied regions in an area surrounding the vehicle (100, 300, 400, 500, 600, 700, 800) and to output corresponding surroundings information (106),
a trajectory-calculation device (107) which is designed to calculate possible first collision-free trajectories for the vehicle (100, 300, 400, 500, 600, 700, 800) on the basis of the surroundings information (106) starting from the start position (103, 303, 403, 503, 603, 703, 803) and to calculate possible second collision-free trajectories for the vehicle (100, 300, 400, 500, 600, 700, 800) starting from the end position (104, 304, 310, 311, 404, 504, 604, 704, 804),
wherein the trajectory-calculation device (107) is also designed to identify at least one pair of first collision-free trajectories and second collision-free trajectories whose trajectory end positions (713, 813, 814) lie within a predefined tolerance range with respect to one another, and to output the at least one pair as a vehicle trajectory (102).

2. The control device (101) according to claim 1, wherein the trajectory-calculation device (107) is designed to calculate the first trajectories and the second trajectories as the shortest possible trajectories.

3. The control device (101) according to claim 1, wherein the tolerance range is predefined in such a manner that it is possible for the vehicle (100, 300, 400, 500, 600, 700, 800), according to its driving physics parameters, to swivel from the trajectory end position (713, 813, 814) of the first trajectory into the trajectory end position (713, 813, 814) of the second trajectory and to follow said trajectory.

4. The control device (101) according to claim 1, wherein the trajectory-calculation device (107) is designed to calculate the first trajectories and the second trajectories as a combination of a circular path and a straight line and/or as a combination of a circular path and a circular path and/or as a combination of a circular path and a circular path and a straight line.

5. The control device (101) according to claim 1, wherein the trajectory-calculation device (107) is designed to calculate the trajectories with a predefined angular resolution starting from the respective initial position.

6. The control device (101) according to claim 1, wherein the trajectory-calculation device (107) is designed to transform the trajectory end positions (713, 813, 814) into a coordinate system of the end position (104, 304, 310, 311, 404, 504, 604, 704, 804) and to check whether the trajectory end positions (713, 813, 814) lie within a predefined tolerance range with respect to one another in the coordinate system of the end position (104, 304, 310, 311, 404, 504, 604, 704, 804).

7. The control device (101) according to claim 1,
wherein the trajectory-calculation device (107) is designed, if the respective trajectory end positions (713, 813, 814) do not lie within a predefined tolerance range with respect to one another for any pair of the first trajectories and the second trajectories, to identify those trajectory end positions (713, 813, 814) of a first trajectory and a second trajectory which have the smallest spacing with respect to one another, and to choose the trajectory end position (713, 813, 814) of the identified second trajectory as the intermediate end position,
wherein the trajectory-calculation device (107) is designed to calculate possible second collision-free trajectories for the vehicle (100, 300, 400, 500, 600, 700, 800) starting from the intermediate end position, and to identify at least one pair of first collision-free trajectories and the second collision-free trajectories calculated on the basis of the intermediate end position whose trajectory end positions (713, 813, 814) lie within the predefined tolerance range with respect to one another.

8. The control device (101) according to claim 7, wherein the trajectory-calculation device (107) is designed to iteratively identify those trajectory end positions (713, 813, 814) of a first trajectory and a second trajectory which have the smallest spacing with respect to one another, and to calculate possible second collision-free trajectories for the vehicle (100, 300, 400, 500, 600, 700, 800) starting from the intermediate end position of the respective second trajectory until at least one pair of first collision-free trajectories and the second collision-free trajectories calculated on the basis of the intermediate end position can be identified whose trajectory end positions (713, 813, 814) lie within the predefined tolerance range with respect to one another.

9. A method for calculating a vehicle trajectory (102) for a vehicle (100, 300, 400, 500, 600, 700, 800) starting from a start position (103, 303, 403, 503, 603, 703, 803) up to an end position (104, 304, 310, 311, 404, 504, 604, 704, 804), having the steps of:
sensing (S1) free and occupied regions in an area surrounding the vehicle (100, 300, 400, 500, 600, 700, 800) and outputting corresponding surroundings information (106),
calculating (S2) first collision-free trajectories for the vehicle (100, 300, 400, 500, 600, 700, 800) on the basis of the surroundings information (106) starting from the start position (103, 403, 503, 603, 703, 803),
calculating (S3) second collision-free trajectories for the vehicle (100, 300, 400, 500, 600, 700, 800) on the basis of the surroundings information (106) starting from the end position (104, 404, 504, 604, 704, 804),
identifying (S4) at least one pair of first collision-free trajectories and second collision-free trajectories whose trajectory end positions (713, 813, 814) lie within a predefined tolerance range with respect to one another, and
outputting (S5) the at least one pair as the vehicle trajectory (102).

10. The method according to claim 9, wherein the first trajectories and the second trajectories are calculated as the shortest possible trajectories.

11. The method according to claim 9, wherein the tolerance range is predefined in such a manner that it is possible for the vehicle (100, 300, 400, 500, 600, 700, 800), according to its driving physics parameters, to swivel from the trajectory end position (713, 813, 814) of the first trajectory into the trajectory end position (713, 813, 814) of the second trajectory and to follow said trajectory.

12. The method according to claim 9, wherein the first trajectories and the second trajectories are calculated as a combination of a circular path and a straight line and/or as a combination of a circular path and a circular path and/or as a combination of a circular path and a circular path and a straight line.

13. The method according to claim 9,
wherein the trajectories are calculated with a predefined angular resolution starting from the respective initial position; and/or
wherein the trajectory end positions (713, 813, 814) are transformed into a coordinate system of the end position (104, 304, 310, 311, 404, 504, 604, 704, 804) and it is checked whether the trajectory end positions (713, 813, 814) lie within a predefined tolerance range with respect to one another in the coordinate system of the end position (104, 304, 310, 311, 404, 504, 604, 704, 804).

14. The method according to claim 9,
wherein if the respective trajectory end positions (713, 813, 814) do not lie within a predefined tolerance range with respect to one another for any pair of the first trajectories and the second trajectories, those trajectory end positions (713, 813, 814) of a first trajectory and a second trajectory are identified which have the smallest spacing with respect to one another, and the trajectory end position (713, 813, 814) of the identified second trajectory is chosen as the intermediate end position,
wherein possible second collision-free trajectories for the vehicle (100, 300, 400, 500, 600, 700, 800) are calculated starting from the intermediate end position, and at least one pair of first collision-free trajectories and the second collision-free trajectories calculated on the basis of the intermediate end position is identified, whose trajectory end positions (713, 813, 814) lie within the predefined tolerance range with respect to one another.

15. The method according to claim 14, wherein those trajectory end positions (713, 813, 814) of a first trajectory and a second trajectory are iteratively identified which have the smallest spacing with respect to one another, and possible second collision-free trajectories for the vehicle (100, 300, 400, 500, 600, 700, 800) are calculated starting from the intermediate end position of the respective second trajectory until at least one pair of first collision-free trajectories and the second collision-free trajectories calculated on the basis of the intermediate end position is identified whose trajectory end positions (713, 813, 814) lie within the predefined tolerance range with respect to one another.
